(19) United States
(12) Patent Application Publication
(10) Pub. No.: US 2015/0292050 A1
(43) Pub. Date: Oct. 15, 2015

(54) BLOWING METHOD AND DEVICE FOR PRODUCING STEEL USING JETS OF HOT AIR

(71) Applicant: PRIMETALS TECHNOLOGIES AUSTRIA GMBH, Linz (AT)

(72) Inventor: Karl BROTZMANN, Amberg (DE)

(73) Assignee: PRIMETALS TECHNOLOGIES AUSTRIA GMBH, Linz (AT)

(21) Appl. No.: 14/646,064

(22) PCT Filed: Nov. 21, 2013
(86) PCT No.: PCT/EP2013/074330

§ 371 Date: May 20, 2015

(30) Foreign Application Priority Data
Nov. 21, 2012 (DE) 10 2012 022 703.5

(51) Int. Cl. C21C 5/32; F27D 3/16; C21C 5/46

(52) U.S. Cl. CPC C21C 5/32; C21C 5/4606; F27D 3/16; F27D 2003/163; F27D 2003/169

(57) ABSTRACT

A blowing method for producing steel from molten raw iron in converters. At least one jet of hot air is sprayed from at least one nozzle of at least one spraying device into the converter chamber onto the molten raw iron. The hot air exiting in the form of a jet has a pressure difference ranging from 0.05-0.1 Mpa between the inlet into the nozzle and the outlet out of the nozzle.

### FIELD OF TECHNOLOGY

The present application relates to methods for producing steel by refinement using jets of hot air in suitable converters.

### PRIOR ART

It is known that steel can be produced from different feedstock using different methods.

According to the so-called blowing method, molten pig iron is refined using gaseous oxygen or air as a refining agent. In this case, heat is released which ensures that the temperature of the molten mass remains above its solidification point. A plurality of different blowing methods are known to a person skilled in the art, depending on how the refining agent is fed into or onto the molten pig iron, e.g. by means of top-blowing methods, bottom-blowing methods, and methods of blowing from both above and below, known e.g. as combined blowing methods. In this case, the molten pig iron may consist of or be obtained from pig iron and scrap and/or other iron bearing solids, for example. In general, heat for melting solid feedstock is primarily provided by the oxidation processes in the molten mass, said processes being caused by the oxygen.

In the context of this application, a converter is understood to be a vessel for performing a blowing method.

In addition to blowing methods, there are also open-hearth methods in which refining does not take place in the same way as blowing methods where air or gaseous oxygen is supplied as an refining agent. Agents for the oxidation of companion elements in molten pig iron are provided by means of added scrap and ore. The term converter in the context of this application does not refer to vessels that are used to perform open-hearth processes. Such vessels are referred to as open-hearth furnaces, for example.

In the case of EF steel making, a large part of the heat that is required to melt solid feedstock is introduced by means of arcing or induction. The term converter in the context of this application does not refer to vessels that are used to perform EF steel making processes. Such vessels are referred to as electric furnaces or electric-arc furnaces.

In the case of bottom-blown converters, it is known that energy can also be introduced into the refining process by postcombustion of the reaction gases, e.g. carbon monoxide CO, by means of hot-air jets which are directed onto the bath. The scrap admixture can then be increased from approximately 230 kg/t steel to 430 kg/t steel. The existing theory is based on the fact that, as a result of the action of the bottom nozzles, a multiplicity of iron droplets are flung into the gas space above the molten mass, forming the surface that is required in order to transfer the high quantity of energy. According to this theory, as a result of the formation of small iron droplets having a diameter of approximately 0.1 mm, the surface of the iron bath is increased by a factor of approximately 10, and therefore the considerable energy from the hot top-blown jet and the postcombustion is transferred to the iron bath.

This view in relation to droplets is also confirmed by the fact that, using top-blown oxygen in a normal converter without bottom nozzles, i.e. without the formation of iron droplets caused by bottom blowing, only approximately 18% of the waste gases are postcombusted, whereas in the case of so-called combined blowing, wherein part of the oxygen is blown in through bottom nozzles, approximately 25% of the process gases are combusted and the energy thus obtained transferred to the iron bath. On the basis of this experience, it is understandable that until now little consideration has been given to the idea of postcombusting the reaction gases and thereby increasing the scrap admixture in an oxygen top-blowing converter, i.e. in a converter without oxygen bottom nozzles.

Unfortunately, postcombustion of reaction gases in converters by means of jets of hot air often results in a considerable discharge of iron and slag droplets.

In the case of converters in which bottom blowing also takes place, a specific bottom-blowing rate is required. Such a bottom-blowing rate supports the creation of iron and slag droplets, which provide a large surface for the transfer of energy from the postcombustion onto the molten iron. It is considered that, for a high transfer of energy onto the molten iron (iron bath), a ten to twenty fold increase is required in comparison with a stationary liquid surface in the converter. However, the iron and slag droplets are easily discharged from the converter through the converter mouth. Particularly when using hot-air jets for the postcombustion in the converter, significant discharge of droplets occurs due to the large gas volume and the high momentum. The present invention takes as its starting point the surprising finding that in a converter which is based on oxygen top-blowing, i.e. blowing without bottom nozzles, it is entirely feasible for reactions to occur which can explain the transfer of energy to the iron bath from the postcombustion of reaction gases by means of hot-air jets.

In this case, the following events are conceivable. There are known to be large differences between the behavior of an oxygen jet and a hot-air jet when top blowing onto an iron bath. A hot-air jet has approximately 10 times the momentum for the same quantity of oxygen. This is particularly apparent when the hot-air jet strikes the surface of the bath. A spray of liquid iron is produced in this case, and energy is transferred to the bath via the droplets. It is therefore also possible to imagine a high transfer of energy being caused by the hot-air jet in a top-blown converter. It must however be ensured that the discharge of droplets from the converter mouth does not become excessive in this case.

In summary, postcombustion of reaction gases by means of hot air using a blowing method in converters has the problem that the discharge of droplets significantly hinders a practical cost-effective implementation.

### SUMMARY OF THE INVENTION

### Technical Problem

The object of the present invention is to propose a method by which the discharge of droplets during postcombustion of reaction gases by means of hot air using a blowing method in converters is limited to an acceptable level. Also proposed is a device for performing such a method.

### Technical Solution

This object is achieved by a

blowing method for producing steel from molten pig iron in converters, characterized in that
at least one jet of hot air is sprayed into the converter space above the molten pig iron from at least one nozzle of at least one spraying device onto the molten pig iron,
wherein a differential pressure of 0.05-0.1 MPa exists, in relation to the hot air emerging as a jet, between entry into the nozzle and exit from the nozzle.

In order to guarantee the effect of the heat transfer to the molten pig iron, which becomes a steel bath during the course of refining, and to prevent the discharge of the droplets from the converter, the hot air is blown onto the bath of pig iron under specific conditions. According to the invention, good conditions are produced if, in relation to the hot air emerging as a jet, a differential pressure of 0.05-0.1 MPa exists between entry into the nozzle and exit from the nozzle. In this case, the pressure at entry into the nozzle should be higher than that at the exit. For example, if atmospheric pressure is present at the exit of the nozzle, e.g. in the converter space above the molten pig iron, the hot air supplied to the nozzle should have a pressure which is 0.05 to 1 MPa higher upon entry into nozzle. A nozzle is understood to be a component which produces a jet from the hot air which is supplied to the nozzle, this being effected by a narrowing of the channel through which the hot air flows. This may take the form of a Venturi nozzle, for example.

Refining is also caused by the jet of hot air.

By virtue of the inventive measures in relation to pressure, conditions are created which significantly reduce the discharge of droplets.

According to a preferred variant, a

blowing method for producing steel from molten pig iron in converters is involved, which is characterized in that a plurality of jets of hot air are sprayed into the converter space above the molten pig iron from a plurality of nozzles of at least one spraying device onto the molten pig iron,
wherein a differential pressure of 0.05-0.1 MPa exists, in relation to the hot air emerging as jets, between entry into the nozzles and exit from the nozzles.

If a plurality of jets are provided, the formation of droplets by the jets is distributed over a wider area, thereby facilitating the deposition of the droplets prior to, and hence the prevention of, their leaving the converter.

In the case of standard converter sizes, it is advisable to spray the hot air in a plurality of jets.

The plurality of jets of hot air should be arranged in such a way that they do not flow into each other due to reciprocal induction before reaching the molten pig iron.

A lance can be used as a spraying device, for example, having one or more nozzle openings from which the one or more jets emerge. However, one or more jets of hot air can also be sprayed in by means of one or more lateral nozzles as spraying devices in the converter mouth. Or a plurality of jets can be provided from both lance and lateral nozzle.

According to a further preferred variant, a

blowing method for producing steel from molten pig iron in converters is involved, which is characterized in that a plurality of jets of hot air are sprayed into the converter space above the molten pig iron from a plurality of nozzles of at least one spraying device onto the molten pig iron,
wherein a differential pressure of 0.05-0.1 MPa exists, in relation to the hot air emerging as jets, between entry into the nozzles and exit from the nozzles
and wherein the jets cover a length of travel between leaving the spraying device and striking the molten pig iron, wherein the jets have a separation of at least 0.03-0.05 times the length of travel when they leave the spraying device.

The maximum separation that can be realized is determined by the outline conditions under which the method is carried out. For example, if spraying is effected by means of a lance as a spraying device, the dimensions of the lance represent a limiting factor in respect of the maximum separation that can be realized.

In order to guarantee the effect of the heat transfer to the molten pig iron, which becomes a steel bath during the course of refining, and to prevent or reduce the discharge of the droplets from the converter, the hot air is blown onto the bath of pig iron under specific conditions according to the invention.

According to the invention, optimal conditions are produced if the diameter of the nozzles of the spraying device, and hence the diameter of the jets of hot air, is 0.03-0.05 times the length of travel of the jets, said length of travel representing the distance between nozzle opening and bath surface measured in the direction of movement of the jet, under the conditions of pressure as per the invention.

### Advantageous Effects of the Invention

A possible explanation for the positive effects that can be achieved by measures according to the invention may be found in the following ideas. As a result of the quantity of gas, which introduces the same quantity of oxygen but is considerably greater than that used in the oxygen top-blowing method, and which can also be introduced with greater momentum, and the consequentially higher flow rate of the waste gases, a discharge of droplets can be prevented if, as a result of the flow in the gas space, conditions are created which result in extensive deposition of the droplets in the converter.

A jet of hot air must therefore be blown onto the surface of the bath in such a way that the flow is deflected towards a converter wall, wherein the droplets are swept along and are deposited by the centrifugal force as a result of the deflection of the flow at the converter wall. The jet should not penetrate too deeply into the bath of molten pig iron, since otherwise a reverse flow in the bath is produced, which is directed more forcefully upwards and therefore iron droplets are discharged through the converter mouth with the flow, i.e. are not adequately deposited by a deflection of the flow at the converter wall.

If the jet penetrates too deeply into the molten pig iron, more iron is then atomized and the reverse flow of the hot gases is adversely affected because the gases, leaving the indentation created in the molten pig iron by the jet of hot air, include a jet component which is directed upwards.

If the jet does not accelerate the droplets parallel to the surface of the molten pig iron sufficiently to deposit them extensively when the flow direction changes at the side wall of the converter, some of the droplets remain in the gas flow and are discharged with the hot gas.

The temperature of the hot air is 800° C. to 1600° C. In the context of this application, the term hot air therefore signifies hot air at 800-1600° C., possibly enriched with a raised oxygen content as specified below. For the purpose of practical applications, a temperature range of 800° C. to 1400° C. is advantageous, and a temperature range of 1000° C. to 1400° C. is particularly advantageous. This temperature range is technically easy to manage and has a high level of thermal efficiency.

A high hot-air temperature has advantages as follows:
Since the thermal content of the hot air is utilized very efficiently, a high hot-air temperature also results in a correspondingly higher energy yield.
The sonic velocity of air is heavily dependent on the temperature. It is approximately 900 m/s at 1200° C. Therefore a flow rate of 600 m/s can already be achieved in the nozzle opening at a modest overpressure of 0.6 bar, thereby assisting the desired flow profile.

The jets should strike the bath of molten pig as individual jets, and not merge in advance of this.

According to a preferred embodiment, at least three jets are provided.

According to a preferred embodiment, the jets are directed away from each other, the directions of the jets relative to each other forming an angle of at least 6°.

The jets are directed as they leave the spraying device, meaning that they are characterized by a primary direction of motion which can be represented by a vector. The angle exists between these vectors of two jets.

As a result of the jets being directed away from each other, they are prevented from flowing into each other before they reach the molten pig iron.

The upper limit for the angle is defined in that the jets of hot air should not strike the lining at the edge of the converter, but should instead strike the bath in the converter, and that sufficient space should remain to produce the direction of the jet towards the edge.

According to a preferred embodiment, the diameter of the jets when they leave the spraying device is 0.01-0.05 times the length of travel. This helps to prevent the jets from flowing into each other before they reach the molten pig iron.

According to a preferred embodiment, the reciprocal separation of a plurality of jets when they leave the spraying device is equal to at least their diameter when they leave the spraying device. This helps to prevent the jets from flowing into each other before they reach the molten pig iron.

Leaving the spraying device is intended to signify leaving the respective nozzle of the spraying device.

According to a preferred embodiment, the jets are directed such that the directions of the jets relative to the vertical form an angle of at least 6°. This helps to prevent the jets from flowing into each other before they reach the molten pig iron.

According to a preferred embodiment provision is made for a central jet, which is directed vertically onto the molten pig iron.

According to a preferred embodiment, peripheral jets are provided in addition to the central jet, the directions of the peripheral jets and the direction of the central jet together forming an angle of at least 6° and preferably at least 8°. The upper limit for the angle is defined in that the peripheral jets of hot air should not strike the lining at the edge of the converter, but should instead strike the bath in the converter, and that sufficient space should remain to produce the direction of the jet towards the edge.

This advantageously results in the central jet generating more droplets than the peripheral jets, and these droplets are then pushed onto the molten pig iron by means of the peripheral jets.

The peripheral jets are preferably arranged symmetrically around the central jet.

The diameter of the central jet as it emerges from the spraying device is preferably at least the diameter of a peripheral jet of hot air. It can also be larger, i.e. a stronger jet.

Surprisingly, the efficiency of the postcombustion can be further improved if, in addition to the inventive arrangement and distribution of the nozzles, a further nozzle is provided in the center of the inventive arrangement, said further nozzle blowing vertically onto the bath surface. This nozzle should be at least as large as the peripheral nozzles according to the invention, wherein these must then be directed outwards by at least 8°, however. The effect of this advantageous nozzle combination can probably be explained in that the central hot-air jet results in additional droplet formation, which then boosts the operation of the peripheral nozzles.

As a rough approximation, this means that in the case of a 100-ton converter at a blowing rate of 30,000 Nm³ hot air/hour, the hot air is blown in through three nozzles having a diameter of approximately 12 cm, and in the case of a 250-ton converter at a blowing rate of 80,000 Nm³ hot air/hour, the hot air is blown in through five nozzles having a diameter of approximately 15 cm. The nozzles must, if they are mounted in a single nozzle system of a spraying device, be characterized by a degree of separation which ensures that the jets of hot air remain discrete jets, i.e. they must not merge into a single jet again before they strike the molten pig iron. This condition is generally satisfied if the separation between the nozzles corresponds to at least the nozzle diameter, and therefore the reciprocal separation of the jets when they leave the spraying device corresponds to at least their diameter when they leave the spraying device, and the jets are angled outwards by at least 6° relative to an upright jet which is directed onto the bath.

According to a preferred embodiment, fuel is supplied to at least one jet.

According to the invention, further energy can be introduced into the steel production process if fuel, preferably containing hydrocarbons and ideally natural gas, is added to the jet of hot air. Even modest supplements, e.g. 1% natural gas relative to the quantity of hot air, already produce noticeable effects. Optimum values are achieved if an amount of natural gas is added which results in approximately 20-40% of the oxygen contained in the jet of hot air being used for the combustion of natural gas. This value is based on the total combustion of natural gas, i.e. according to the invention approximately 5 Nm³ natural gas is added per 100 Nm³ of hot air that is not oxygen-enriched.

The fuel can also be coal dust, for example.

According to a preferred embodiment, the hot air is enriched with oxygen, preferably up to 40%. Greater enrichment would cause significantly more wear to the spraying device.

A particularly important application of the invention relates to increasing the heat that is introduced into the steel production process, while simultaneously increasing the fuel value of the waste gas. During normal postcombustion of converter process gases using hot air, a waste gas is produced which has so little fuel value that it can no longer be processed in conventional waste-gas treatment plants which operate without total combustion. It must therefore be totally combusted with air in the hot state after leaving the converter, thereby significantly increasing the quantity of waste gas. With regard to the adaptation of conventional converters to a process which includes hot-air postcombustion, the capacity of existing waste-gas treatment plants therefore restricts the adaptation of an existing converter to the new method.

If the hot air is so enriched as to have an oxygen content of approximately 30%, resulting in a low level of postcombustion, it is possible to compensate almost completely for any reduction in the level of postcombustion by adding natural gas to the hot-air jet in accordance with the invention. Optimum values are achieved if 30-50% of the oxygen contained in the hot air is combusted with natural gas.

If the hot air is so enriched as to have an oxygen content of 30%, an average level of postcombustion of 55% is achieved using a supplement of 4% by volume natural gas relative to the quantity of hot air. In this case, the natural gas does not have to be mixed with the hot air as in the case of a burner. Rather, it is sufficient to blow the fuel via a tube or a plurality of tubes into the jet of hot air in the vicinity of its exit from the spraying device.

In both cases, a high level of postcombustion is again achieved with the oxygen enrichment of the hot air when the inventive method is applied. The specific energy yield also increases in this case, and at the same time a high-energy waste gas is obtained which can be collected and used in the conventional manner in existing waste-gas plants.

According to an embodiment, the blowing method is a top-blowing method, wherein the plurality of jets of hot air are sprayed into the converter space above the molten pig iron from at least one spraying device onto the molten pig iron in a first phase of the refining process, and

after the first phase has terminated, refining is completed using oxygen in a second phase without spraying the jets of hot air.

The at least one spraying device is arranged in the upper region of the converter. It comprises hot-air nozzles through which the hot air is sprayed in jets, and may take the form of a hot-air lance, for example, which is removed after the first phase. The jets of hot air are directed onto the bath of molten pig iron which is located in the converter. A oxygen top-blowing lance is used for refining in the second phase.

The temporal distribution over the two phases depends on how much additional energy is to be introduced into the converter process. When refining pig iron, for example, if the scrap admixture need only be increased by 5%, i.e. from e.g. 230 kg scrap/t steel to 280 kg scrap/t steel, it is sufficient for 20% of the required quantity of oxygen to be top-blown using jets of hot air.

In order make optimum use of the increase in the scrap admixture, approximately 80% of the oxygen is top-blown using hot air and the remaining 20% is top-blown using oxygen alone at the end of the refining process. For this purpose the hot-air nozzles are removed and refining of the molten mass is completed using oxygen in the usual manner. In this example, e.g. an increase of the scrap admixture from 230 kg/t steel to 390 kg/t steel is achieved. The top blowing of oxygen at the end of the process is required in order to achieve the required steel quality.

In an oxygen top-blowing converter, energy for the purpose of increasing the scrap admixture is also introduced by virtue of only hot air being top-blown in a first phase of the refining process and only oxygen being top-blown in a second phase of the refining process. The energy yield is significantly increased by adding e.g. natural gas to the jet of hot air.

The application of the invention in relation to oxygen top-blowing methods is now explained in greater detail with reference to two examples:

The first example relates to the production of steel from pig iron and scrap in an oxygen top-blowing converter having a melting capacity of 100 t, said converter being operated using hot-air jets as per the invention at the beginning of the refining process. Before the adaptation, 900 kg pig iron and 180 kg scrap were charged into the converter for one ton of steel. As a result of the hot-air postcombustion of the converter gas, the scrap admixture is increased to 350 kg/t steel when using the method according to the invention. The level of postcombustion is 55%. The existing waste-gas collection plant can accommodate a maximum of 35,000 Nm³/h. As a result of using hot air instead of oxygen, the melting time is extended from 20 minutes to 25 minutes due to the specified limit on the quantity of waste gas, otherwise the waste gas cannot be reprocessed.

If 4 Nm³ natural gas/100 Nm³ hot air is added to the hot air, and the oxygen content of the hot air is enriched to 30%, the blowing time is 18 minutes for a hot-air blowing rate of 32,000 Nm³/h. The quantity of scrap that can be melted down increases to 400 kg/t steel, top-blown hot air being used for 14 minutes of refining and top-blown oxygen being used for the remaining 4 minutes. The level of postcombustion is again 60%, but a gas is produced whose fuel value is so high that it can be collected in standard converter waste-gas plants.

In both applications, the top blowing of hot air is stopped after 80% of the melting time, and refining of the molten mass is completed using the oxygen top-blowing lance.

According to an embodiment variant, the blowing method is a bottom-blowing method.

In the case of a bottom-blowing method, the opening for the reaction gases or waste gases is situated above the injection zone formed by bottom-blowing nozzles. The hot air is used for postcombustion of the reaction gases. The jets of hot air are preferably blown in through nozzles whose diameter is 0.01-0.03 times the length of travel of the jets of hot air. In the case of a plurality of nozzles, the separation between the nozzle openings is at least as great as the nozzle diameter. In the case of a plurality of nozzles in a nozzle head, the individual nozzles are preferably directed outwards by at least 8°. The opening for the jets of hot air is preferably situated within the converter mouth.

The application of the invention in relation to bottom-blowing methods is now explained in greater detail with reference to two examples:

In a first example, the inventive method is applied in the context of a bottom-blown converter. A considerable quantity of energy is available in the process gases that are produced, and said energy can be supplied to the processes occurring in the converter, e.g. melting processes, by means of postcombustion with hot air. In this way, e.g. the scrap admixture which is approximately 200 kg/t steel in the case of bottom-blown converters that operate without postcombustion can be increased by approximately 200 kg/t steel.

In the exemplary application, approximately 700 kg/pig iron/t steel and 400 kg scrap/t steel are charged into a 60-ton converter. Refining takes place in the usual way using oxygen via bottom nozzles at a blowing rate von 6,000 Nm³/h, and simultaneously by means of a hot-air lance which is introduced into the converter mouth and has a blowing rate of 30,000 Nm³/h hot air that is so enriched as to have an oxygen content of 30%. The length of travel of the jets of hot air is 3.5 m. The jets of hot air emerge from three nozzle openings which have a diameter of 13 cm each and are so arranged as to have a separation of 15 cm in the hot-air lance. The jets are angled outwards by at least 8° relative to the vertical. When the carbon content in the bath reaches the region of 1%, the top blowing of hot air is terminated, the hot-air lance is withdrawn, and refining of the charge is completed in the usual manner via bottom nozzles.

In a second example relating to a bottom-blowing method, steel is produced in a 250-ton converter under the same conditions as in the first example for a bottom-blowing method. The length of travel of the jets of hot air is 5 m. The hot-air blowing rate is 80,000 Nm³/h. Five nozzle openings, each having a diameter of 15 cm, are provided in the hot-air lance. The separation between the nozzles is 17 cm. The nozzles are arranged annularly in the lance, said nozzles having a separation of 20 cm from the center of the lance and 20 cm between the nozzles in each case. The direction of the jets is directed outwards by at least 8° in each case. The hot-air lance has a diameter of approximately 70 cm.

The present invention also relates to a device for executing a method according to the invention, comprising a spraying device which is suitable for spraying jets of hot air into a converter space above molten pig iron in the converter, said jets of hot air leaving the spraying device through nozzles, characterized in that the nozzle openings of the nozzles have a reciprocal separation which is equal to at least 0.03-0.05 times the length of travel.

The hot air emerges through the nozzle openings of the nozzles.

A smaller separation would cause jets of hot air emerging from the nozzle openings to merge into a single jet, since each jet attracts gas from its surroundings. The individual jets must therefore have a minimum separation in order to prevent them from merging. The jets then strike the bath of molten pig iron as discrete jets.

According to a preferred embodiment, provision is made for at least three nozzle openings. A specific quantity of hot air is then distributed efficiently as it is sprayed in, resulting in better postcombustion of reaction gases. Moreover, any formation of droplets is distributed over a plurality of locations, thus making it easier to prevent the discharge of droplets.

Concerning the number of nozzle openings, the conditions relating to separation of the nozzle openings must obviously be satisfied.

According to a preferred embodiment, the longitudinal axes of the nozzles together form an angle of at least 6°.

The nozzles have longitudinal axes which together form an angle of at least 6°. This lessens the risk that a plurality of jets will merge.

According to a preferred embodiment, the reciprocal separation of the nozzle openings is at least as great as the diameter of the nozzle openings.

According to a preferred embodiment, a central nozzle is provided. A jet of hot air can be directed vertically onto the molten pig iron therefrom.

According to a preferred embodiment, peripheral nozzles are provided in addition to the central nozzle, the longitudinal axes of the peripheral nozzles and the longitudinal axis of the central nozzle together forming an angle of at least 6° and preferably at least 8°.

According to a preferred embodiment, the spraying device is a hot-air lance, i.e. a lance which is suitable for spraying in hot air.

During operation, the spraying device is preferably positioned such that, in the case of a plurality of jets, the jets of hot air emerge therefrom in the converter mouth, i.e. not outside the converter. If only one jet is provided, being directed as per the inventive method from e.g. a hot-air lance in the direction of the extension of the longitudinal axis thereof and onto the molten pig iron, said jet may also emerge therefrom outside of the converter mouth, i.e. outside the converter.

The nozzle openings are the ends of the nozzles from which jets of hot air emerge.

### BRIEF DESCRIPTION OF THE DRAWINGS

The invention is explained with reference to schematic exemplary illustrations of embodiment variants, wherein:

FIG. 1 schematically shows an inventive top-blowing method in the first phase;

FIG. 2 schematically shows an inventive bottom-blowing method;

FIG. 3 shows an arrangement of nozzles in a nozzle head;

FIG. 4 shows another arrangement of nozzles in a nozzle head; and

FIG. 5 shows a blowing method with a central jet of hot air.

### DESCRIPTION OF THE EMBODIMENT VARIANTS

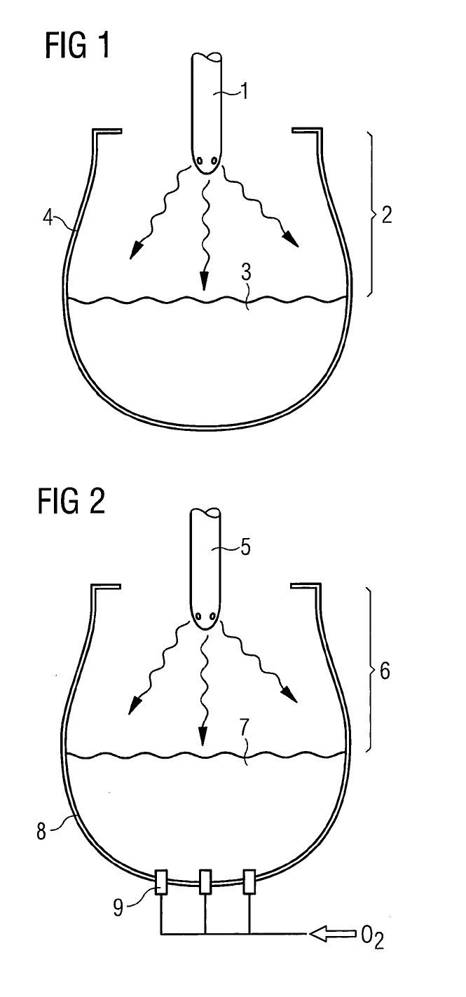

FIG. 1 schematically shows an inventive top-blowing method in the first phase of the refining process. A plurality of jets of hot air, illustrated by wavy arrows, are sprayed from a hot-air lance 1 into the converter space 2 above the molten pig iron 3. The molten pig iron 3 is situated in the converter 4.

FIG. 2 schematically shows an inventive bottom-blowing method. A plurality of jets of hot air illustrated by wavy arrows are sprayed from a hot-air lance 5 into the converter space 6 above the molten pig iron 7. The molten pig iron 7 is situated in the converter 8. Oxygen for the purpose of refining is introduced into the molten pig iron 7 via bottom nozzles 9.

FIG. 3 shows the manner in which nozzles are arranged relative to each other in a nozzle head comprising three nozzles in a spraying device hot-air lance. The angle between the intersecting longitudinal axes as marked by a dashed line is 8°.

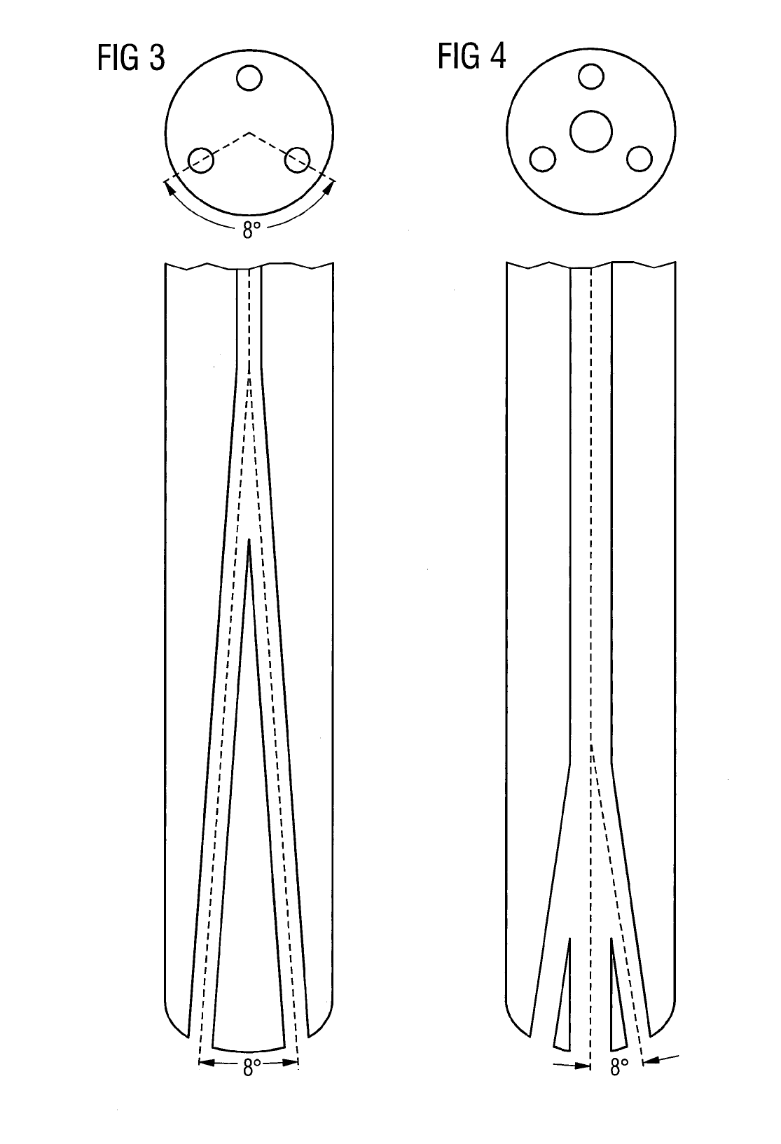

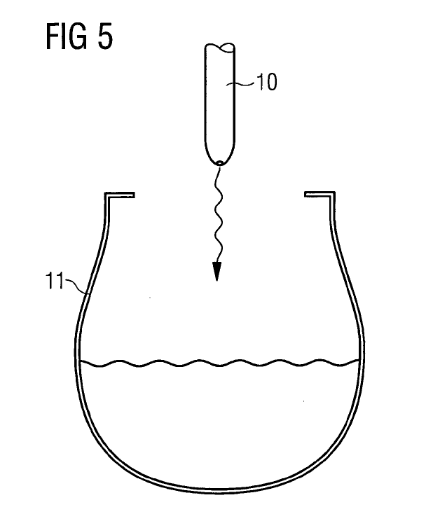

FIG. 4 shows an arrangement for a spraying device hot-air lance in which a central nozzle and three peripheral nozzles are provided in the nozzle head. The longitudinal axes of the peripheral nozzles and the longitudinal axis of the central nozzle together form an angle of 8° as illustrated with reference to a peripheral nozzle and the central nozzle, these having longitudinal axes as marked by a dashed line.

In FIGS. 1 and 2, a plurality of jets of hot air emerge in the converter mouth from the spraying device. FIG. 5 shows the manner in which a jet, as illustrated by a wavy arrow, emerges from the hot-air lance 10 outside the converter 11, in the direction of an extension of the longitudinal axis of the hot-air lance 10. The hot-air lance has a vertical longitudinal axis, and therefore the jet of hot air emerges vertically. FIG. 5 is suitable for a top-blowing method or a bottom-blowing method.

The composition of the molten metal in the converter naturally changes during the course of the method. The term molten pig iron is intended to signify the molten metal in the converter throughout the refining process.

Although the invention is illustrated and described in detail with reference to the preferred exemplary embodiments, the invention is not limited by the examples disclosed herein and other variations may be derived therefrom by a person skilled in the art, without thereby departing from the scope of the invention.

### LIST OF REFERENCE SIGNS

1 Hot-air lance
2 Converter space above the molten pig iron
3 Molten pig iron
4 Converter
5 Hot-air lance
6 Converter space above the molten pig iron
7 Molten pig iron
8 Converter
9 Bottom nozzle
10 Hot-air lance
11 Converter

1) A blowing method for producing steel from molten pig iron in a converter, comprising:
spraying at least one jet of hot air from at least one nozzle of at least one spraying device into a converter space above molten pig iron and onto the molten pig iron, wherein there is a differential pressure of 0.05-0.1 MPa in relation to the hot air emerging as a jet, between entry into the at least one nozzle and exit from the at least one nozzle.

2) The method as claimed in claim 1, further comprising:
spraying a plurality of the jets of hot air into the converter space above the molten pig iron from a plurality of the nozzles of the at least one spraying device and onto the molten pig iron, wherein there is a differential pressure of 0.05-0.1 MPa, in relation to the hot air emerging as jets, between entry into the nozzles and exit from the nozzles.

3) The method as claimed in claim 2, further comprising the jets of hot air cover a distance of travel between leaving the spraying device and striking the molten pig iron, and the jets have a separation of at least 0.03-0.05 times the distance of travel when they leave the spraying device.

4) The method as claimed in claim 2, further comprising at least three of the jets.

5) The method as claimed in claim 3, wherein the jets are directed away from each other, wherein the directions between two of the jets together form an angle of at least 6°.

6) The method as claimed in claim 5, wherein the diameter of the jets when they leave the spraying device is 0.01-0.05 times the distance of travel of the jet.

7) The method as claimed in claim 6, wherein the reciprocal separation of the jets when they leave the spraying device is equal to at least the diameter of the jets when the jets leave the spraying device.

8) The method as claimed in claim 7, wherein the jets are directed such that the directions of the jets relative to the vertical form an angle of at least 6°.

9) The method as claimed in claim 2, further comprising a central jet directed vertically onto the molten pig iron.

10) The method as claimed in claim 9, further comprising peripheral jets in addition to the central jet, wherein the directions of the peripheral jets and the direction of the central jet together each form an angle of at least 6°.

11) The method as claimed in claim 1, further comprising supplying fuel to at least one of the jets.

12) The method as claimed in claim 1, further comprising enriching the hot air with oxygen.

13) The method as claimed in claim 1, wherein the blowing of hot air is a top-blowing method.

14) The method as claimed in claim 1, wherein the blowing of hot air is a bottom-blowing method.

15) A device for executing the method as claimed in claim 1, comprising:
a converter configured for holding molten pig iron and including a converter space in the converter above the molten pig iron;
a spraying device configured for spraying jets of hot air into the converter space above the molten pig iron, and wherein the jets are configured so that the jets of hot air leave the spraying device through nozzles, and nozzle openings of the nozzles have a reciprocal separation which is equal to at least 0.03-0.05 times the distance of the travel of the jets.

16) The device as claimed claim 15, comprising at least three of the nozzle openings.

17) The device as claimed in claim 16, wherein the longitudinal axes of the nozzles together form an angle of at least 6°.

18) The device as claimed in claim 16, wherein a reciprocal separation of the nozzle openings is at least equal to a diameter of the nozzle openings.

19) The device as claimed in claim 15, further comprising a central nozzle for spraying a jet of hot air toward the molten iron.

20) The device as claimed claim 19, further comprising peripheral nozzles in addition to the central nozzle, wherein the nozzles have longitudinal axes, and the longitudinal axes of the peripheral nozzles and the longitudinal axis of the central nozzle together form an angle of at least 6°.

21) The device as claimed in claim 15, wherein the spraying device is a hot-air lance.
